(19) United States
(12) Patent Application Publication
(10) Pub. No.: US 2022/0035710 A1
(43) Pub. Date: Feb. 3, 2022

(54) OPERATING SYSTEM RECOVERY ACTIONS

(71) Applicant: Hewlett-Packard Development Company, L.P., Spring, TX (US)

(72) Inventors: Divyansh Jindal, Pune (IN); Narendra Kumar Chincholikar, Pune (IN)

(21) Appl. No.: 17/387,809

(22) Filed: Jul. 28, 2021

(30) Foreign Application Priority Data
Jul. 30, 2020 (IN) 202041032778

(51) Int. Cl. G06F 11/14; G06F 9/48; G06N 20/00

(52) U.S. Cl. CPC G06F 11/1415; G06F 2201/805; G06N 20/00; G06F 9/4831

(57) ABSTRACT

In an example implementation according to aspects of the present disclosure, a system comprising a processor and a memory. The memory comprises instructions that when executed cause the processor to receive a set of telemetry from client computing device. The processor applies a data model to the set of telemetry. The processor assigns a priority to an operating system recovery action based on the data modeling. The processor blocks the operating system recovery action based on the priority exceeding a first threshold.

### BACKGROUND

Client computing devices host operating systems. Operating systems handle the interfacing of the hardware of the client computing device and provide abstraction layers for applications to execute in a common framework.

### BRIEF DESCRIPTION OF THE DRAWINGS

FIG. 1 is a block diagram of a system supporting operating system recovery actions, according to an example;

FIG. 2 is a block diagram corresponding to a method for blocking operating system recovery actions, according to an example;

FIG. 3 is a block diagram of components used to support operating system recovery actions, according to an example; and

FIG. 4 is a computing device for supporting instructions for operating system recovery actions, according to an example.

### DETAILED DESCRIPTION

A client computing device hosts an operating system. The operating system handles basic hardware interfacing, as well as providing a framework for applications to execute within the client computing device. Often, the operating system may become corrupted or misconfigured to a point where the operating system malfunctions. One resolution to the malfunctioning of an operating system is to recover the operating system, or an operating system recovery action.

In one example, a recovery agent executes within the operating system. The recovery agent may include instructions to retrieve or receive operating system recovery actions and execute them. The instructions may include downloading an operating system installation image to a specific storage location on the client computing device. Additionally, the recovery agent may receive drivers intended for the specific client computing device to be recovered. The recovery agent may inject the drivers into the operating system installation image and start the recovery or reinstallation process.

In another implementation, firmware may come configured with additional nonvolatile memory to host executable instructions to automatically apply an operating system image in place. The firmware instructions may receive both the operating system image to recover, drivers to inject into the operating system image, as well as instructions on how to recover the operating system. In this example, the operating system recovery may be non-interactive, and require little to no user interaction.

In fleet deployments of client computing devices, operating systems may be in various states and may or may not succeed in operating system recovery actions, based on criteria within these states. Based on this variance, the operating system recovery action often fails resulting in unwanted highly technical user interaction or an unbootable computing device. Disclosed herein is a system, method and computer readable medium for supporting operating system recovery actions. The system, method and computer readable medium present an approach to recognize potential operating system recovery failures prior to the recovery, and then prioritize the actual recovery itself.

In one implementation of the present disclosure, a system including a processor and a memory, receive a set of telemetry from a client computing device, apply a data model to the set of telemetry, assign a priority to an operating system recovery action based on the data modeling, and block the operating system recovery action based on the priority exceeding a first threshold.

In another implementation, the system may delay the operating system recovery action based on the priority exceeding a second threshold and not exceeding the first threshold.

A operating system recovery action may be a digital notification sent to the client computing device to provide instruction to a receiver how to process an operating system reinstallation. A operating system recovery action may include but is not limited to a blocking message to stop the operating system reinstallation, or a delay message to postpone the operating system reinstallation until a later date.

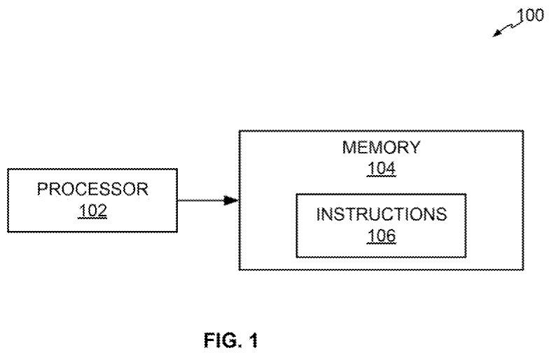

FIG. 1 is a block diagram of a system 100 supporting operating system recovery actions, according to an example. The system 100 may include a processor 102, memory 104 and instructions 106.

The processor 102 of the system 100 may be implemented as dedicated hardware circuitry or a virtualized logical processor. The dedicated hardware circuitry may be implemented as a central processing unit (CPU). A dedicated hardware CPU may be implemented as a single to many-core general purpose processor. A dedicated hardware CPU may also be implemented as a multi-chip solution, where more than one CPU are linked through a bus and schedule processing tasks across the more than one CPU.

A virtualized logical processor may be implemented across a distributed computing environment. A virtualized logical processor may not have a dedicated piece of hardware supporting it. Instead, the virtualized logical processor may have a pool of resources supporting the task for which it was provisioned. In this implementation, the virtualized logical processor may actually be executed on hardware circuitry; however, the hardware circuitry is not dedicated. The hardware circuitry may be in a shared environment where utilization is time sliced. In some implementations the virtualized logical processor includes a software layer between any executing application and the hardware circuitry to handle any abstraction which also monitors and save the application state. Virtual machines (VMs) may be implementations of virtualized logical processors.

A memory 104 may be implemented in the system 100. The memory 104 may be dedicated hardware circuitry to host instructions for the processor 102 to execute. In another implementation, the memory 104 may be virtualized logical memory. Analogous to the processor 102, dedicated hardware circuitry may be implemented with dynamic ram (DRAM) or other hardware implementations for storing processor instructions. Additionally, the virtualized logical memory may be implemented in a software abstraction which allows the instructions 106 to be executed on a virtualized logical processor, independent of any dedicated hardware implementation.

The system 100 may also include instructions 106. The instructions 106 may be implemented in a platform specific language that the processor 102 may decode and execute. The instructions 106 may be stored in the memory 104 during execution. The instructions 106 may be encoded to perform operations such as receiving a set of telemetry from a device, applying a data model to the set of telemetry, assigning a priority to an operating system recovery action based on the data modeling, and blocking the operating system recovery action based on the priority exceeding a first threshold. Instructions 106 may also be implemented as also delaying the operating system recovery action based on the priority exceeding a second threshold and not exceeding the first threshold.

In another implementation, the instructions 106 may be implemented as also blocking the operating system recovery action based on the priority exceeding a first threshold.

Additionally, the system 100 may include other components to support the instructions 106 which are not shown. For example, the instructions include sending notifications to third party systems (e.g. automated support systems). Communication to the client computing devices may be implemented via networking infrastructure (not shown). For example, the system 100 may be interfaced with a personal area networks, local area network, a wide area network, or the internet utilizing industry standardized networking interfaces.

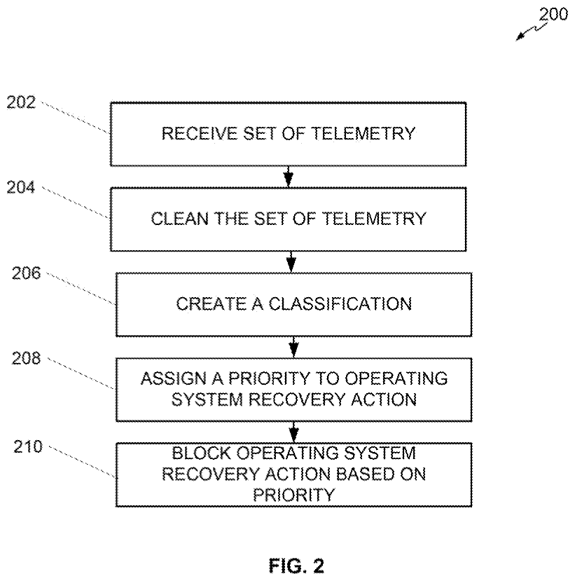

FIG. 2 is a block diagram 200 corresponding to a method for blocking operating system recovery actions, according to an example. The method as described in relation to FIG. 2 may be implemented within the system illustrated in FIG. 1. References to features in FIG. 1 may be utilized to describe parts of the system 100 providing support for the features referenced in FIG. 2.

Starting at 202, the processor 102 receives a set of telemetry from a client computing device at 202. The set of telemetry may include information relating to the current operating state of the client computing device. In other words, the set of telemetry may be a snapshot of the client computing device at the point in time when it is captured. Table 1 illustrates a subset of the telemetry data provided corresponding to the client computing device.

TABLE 1

| Category | Feature | Description |
|---|---|---|
| System Biosphere | Event ID | 40- Recovery Started |
| | | 41- Recovery Completed |
| | | 42- Recovery Failed |
| | Description | Defines the detailed level |
| | | of activity along with the |
| | | error logs found during |
| | | installation |
| Operating System | Name | Name of OS |
| | Version | Version of OS to be |
| | | installed |
| | Type of OS | Defines OS Type (e.g. |
| | | Windows, Linux, Android) |
| | OS Release | Release number of OS |
| Recovery Settings | BIOSCF | BIOS Configuration flag |
| | Recf | Recovery flag |
| | Scheddata | Frequency of the recovery |
| | | to be initiated |
| | osrecovery | OS recovery URL |
| | osrecimgurl | OS recovery Image URL |
| | osrecagenturl | OS recovery agent URL |
| | mstatus | Management status of the |
| | | recovery |

Additionally, within the set of telemetry data, categories corresponding to networking speed, system memory, system battery, system graphics, system processor, thermals, physical drives, and biosphere may be included. Each category may include Feature names that further delineate a categorical difference between each client computing device. The variety of categories, feature names, and descriptions allow for the classification and likewise identifying a priority of the operating system recovery action.

The processor 102 cleans the set of telemetry resulting in a clean data set at 204. The processor 102 may clean the set of telemetry by removing outlier data, imputing nulls, and replacing invalid values utilizing means, previous entry, next entry, and most frequent techniques. Additionally, colinear zero importance features may be removed.

The processor 102 creates a classification based on applying a classification machine learning algorithm to the clean data set at 206. Supervised learning may be utilized for predictive purposes. Supervised classification learning models applicable to the set of telemetry data may include support vector machines (SVN), K-nearest neighbor (KNN). Decisions trees (e.g. Classification trees), and Random Forest. The set of telemetry data may be divided into a distribution of eighty percent train and ten percent test. Other combinations of train versus testing proportions may also be used. The training may include developing a model utilizing real world sets of telemetry data against classifications observed (e.g. failed recovery). For example, an SVN may utilize the cleaned data set derived from the set of telemetry data to construct a multi-dimensional hyperplane for classification. The training step may create the hyperplane and the testing step may validate the hyperplane. In the SVM implementation, a probability may be calculated utilizing Platt scaling.

The processor 102 assigns a priority to an operating system recovery action based on the classification at 208. Once a predictive classification has been determined, a priority may be assigned. The priority assignment may be based on a period of time between the classification and a scheduled operating system recovery event, wherein the operating system may be reinstalled. In one implementation, a priority may include a “High. Medium, and Low” ranking system. Table 2 illustrates how the priority may be assigned in an implementation.

TABLE 2

| | | Mode of communication |
|---|---|---|
| Priority | Criteria | to user |
| High | # of days between 0 to 1 | Next activity should be |
| | | stopped |
| Medium | # of days between 2 to 4 | High Importance email to |
| | | user/company |
| Low | # of days 5 or greater | Email notification to |
| | | user/company |

As illustrated in Table 2, if a classification is determined that an operating system recovery action may fail for a client computing device, and the criteria of a scheduled re-installation during the 0-1 day window of Table 1, the activity should be stopped. A probability from the previously mentioned support vector machine implementation may also be utilized in creating a priority. Probability values in combination classifications may indicate higher or lower priority.

The processor 102 blocks the operating system recovery action based on the priority exceeding a first threshold at 210. In one implementation, a first threshold (e.g. a High priority) is met with a classification of anticipated failure of operating system reinstallation, the processor 102 may block the operating system recovery action. In this implementation, the processor 102 may send a notification to an end point management system executing on the client computing device, indicating commands to abort the operating system recovery action. In another implementation, where the first threshold is High, and a second threshold is Medium, the processor 102 may not block the operating system recovery action, but instead may delay the action and provide a notification through a third-party system, such as email.

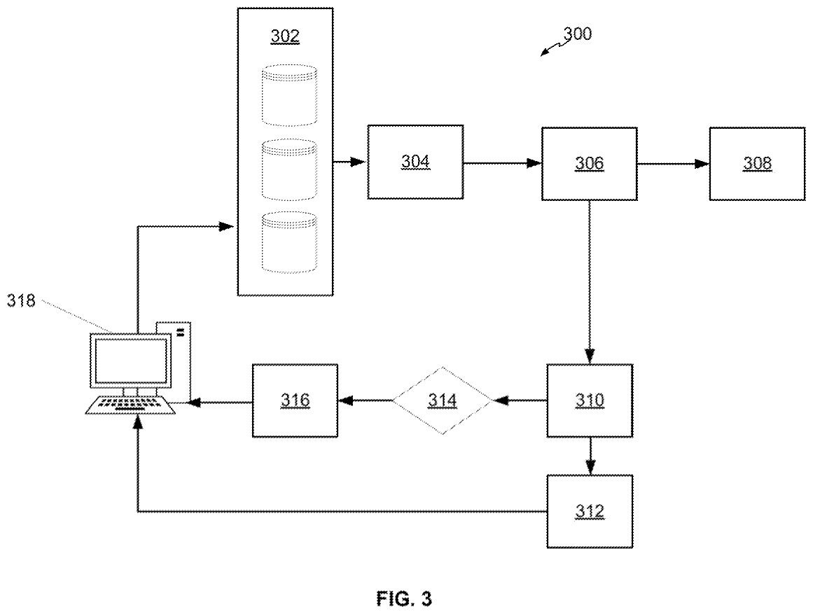

FIG. 3 is a block diagram 300 of components used to support operating system recovery actions, according to an example. The components illustrated in FIG. 3 may correspond to instructions executed on the processor 102 illustrated in FIG. 1. FIG. 3 illustrates one implementation of the system 100 to support operating system recovery actions.

A client computing device 318 provide the set of telemetry data to the system 100. In FIG. 3, the client computing device 318 is illustrated as a desktop personal computer, however the client computing device may be of different computing form factors such as notebooks, tablet and smart phones. Additionally, the client computing device 318 may also take the form of virtual machines.

Within the system are the data sources 302. The data sources 302 are illustrated as a plurality of databases. The data sources 302 may correspond to logical storage organization or structures to store the set of telemetry data prior to any cleaning or processing. The data sources 302 may be utilized in microservice engines providing the set of telemetry data to other systems.

The machine learning module 304 provides the support for applying the machine learning algorithm to the set of telemetry data. Additionally, the machine learning module 304 may provide the data cleaning support in order to have reliable output from the machine learning algorithm. In another implementation, the machine learning module 304 may be utilized for feature selection within the data cleaning step, prior to the application of the supervised machine learning model.

The application module 306 then transforms the machine learning module 304 output into a usable format. For example, the resultant classification may be mapped in the application module 306 back to a database within the application module corresponding to the client computing device. Additionally, common client computing device classifications as well as other telemetry metrics may be aggregated for an organization. Through the aggregation and the mapping of the classification, trends may be determined at the application module 306.

The application module 306 may push visualized information to a dashboard 308 to illustrate trends. While the operating system recovery actions apply to individual client computing devices 318, the dashboard 308 may see an aggregation of classification of a plurality of client computing devices 318 across a fleet of devices. The dashboard 308 may illustrate systemic problems within a fleet of client computing devices 318 allowing an information technology officer to proactively make decisions before operating system recovery actions fail.

A rule engine 310 may apply the priority to the operating system recovery action based on a time value for an upcoming operating system reinstall. As discussed in reference to Table 2, this may be determined as time-based thresholds by a system administrator. A decision point 314 determines if a client computing device is needing OS recovery. The decision point 314 corresponds to evaluating a pre-selected operating reinstallation schedule.

An end user infrastructure 316 provides any files utilized in the operating system recovery. The file may include an operating system image, as well as device drivers specific to the respective client computing device 318. Additionally, configuration details may be transmitted via the end user infrastructure. The end user infrastructure may include an end point management system. The end point management system may enforce client computing device 318 policies corresponding to predetermined rules established by an information technology officer.

The priority application module 312 sends block or delay action. The priority application module 312 receives the priority from the rule engine 310 and interfaces an appropriate interface to send the block or delay action to the client computing device 318. In one implementation, the telemetry agent may operate as the receive or the delay or block operating system recovery action. In another implementation, the priority application module 312 may also interface a third-party communication system (e.g. email server) to provide an information technology officer a notification corresponding to the operating system recovery action.

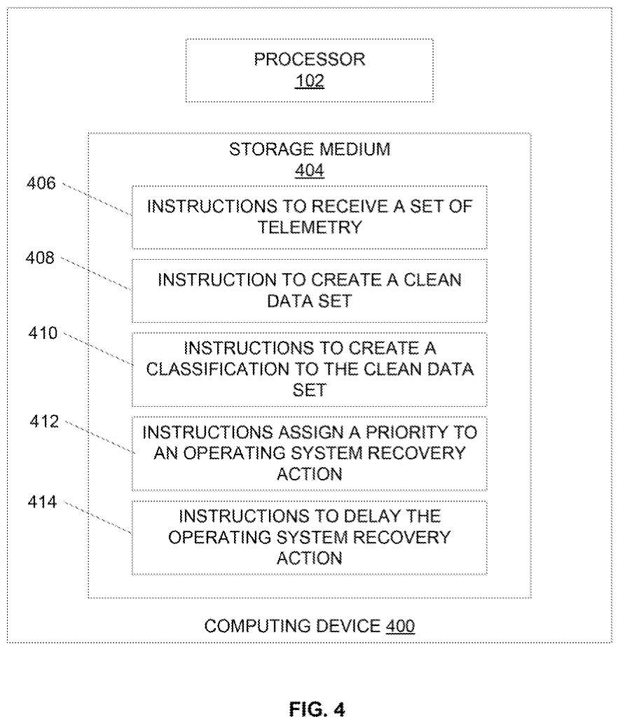

FIG. 4 is a computing device for supporting instructions for supporting instructions for operating system recovery actions, according to an example. The computing device 400 depicts a processor 102 and a storage medium 404 and, as an example of the computing device 400 performing its operations, the storage medium 404 may include instructions 406-414 that are executable by the processor 102. The processor 102 may be synonymous with the processor 102 referenced in FIG. 1. Additionally, the processor 102 may include but is not limited to central processing units (CPUs). The storage medium 404 can be said to store program instructions that, when executed by processor 102, implement the components of the computing device 400.

The executable program instructions stored in the storage medium 404 include, as an example, instructions to receive a set of telemetry from a device 406, instructions to create a clean data set based on a cleaning of the set of telemetry 408, instructions to create a classification based on applying a classification machine learning algorithm to the clean data set 410, instructions to assign a priority to an operating system recovery action based on the classification 412, and instructions to delay the operating system recover action based on the priority not exceeding a first threshold and exceeding a second threshold 414.

Storage medium 404 represents generally any number of memory components capable of storing instructions that can be executed by processor 102. Storage medium 404 is non-transitory in the sense that it does not encompass a transitory signal but instead is made up of at least one memory component configured to store the relevant instructions. As a result, the storage medium 404 may be a non-transitory computer-readable storage medium. Storage medium 404 may be implemented in a single device or distributed across devices. Likewise, processor 102 represents any number of processors capable of executing instructions stored by storage medium 404. Processor 102 may be integrated in a single device or distributed across devices. Further, storage medium 404 may be fully or partially integrated in the same device as processor 102, or it may be separate but accessible to that computing device 400 and the processor 102.

In one example, the program instructions 406-414 may be part of an installation package that, when installed, can be executed by processor 102 to implement the components of the computing device 400. In this case, storage medium 404 may be a portable medium such as a CD, DVD, or flash drive, or a memory maintained by a server from which the installation package can be downloaded and installed. In another example, the program instructions may be part of an application or applications already installed. Here, storage medium 404 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a processor; and
a memory, communicatively coupled to the processor, comprising
instructions that when executed cause the processor to:
receive a set of telemetry from client computing device;
apply a data model to the set of telemetry;
assign a priority to an operating system recovery action based on the data modeling; and
block the operating system recovery action based on the priority exceeding a first threshold.

2. The system of claim 1, wherein the recovery action comprises an operating system reinstallation.

3. The system of claim 1, wherein the set of telemetry correspond to a current client computing device state.

4. The system of claim 1, further comprising the instructions that when executed cause the processor to:
delay the operating system recovery action based on the priority exceeding a second threshold and not exceeding the first threshold.

5. The system of claim 1, wherein the data model is a k-nearest neighbor algorithm.

6. A method comprising:
receiving a set of telemetry from a client computing device;
cleaning the set of telemetry resulting in a clean data set;
creating a classification based on applying a classification machine learning algorithm to the clean data set;
assigning a priority to an operating system recovery action based on the classification; and
blocking the operating system recovery action based on the priority exceeding a first threshold.

7. The method of claim 6, wherein the recovery action comprises an operating system reinstallation.

8. The method of claim 6, wherein the set of telemetry correspond to a current client computing device state.

9. The method of claim 6, further comprising:
delaying the operating system recovery action based on the priority exceeding a second threshold and not exceeding the first threshold.

10. The method of claim 8 wherein the classification machine learning algorithm comprises a Random Forest.

11. A non-transitory computer readable medium comprising instructions executable by a processor to:
receive a set of telemetry from a client computing device;
create a dean data set based on a cleaning of the set of telemetry;
create a classification based on applying a classification machine learning algorithm to the clean data set;
assign a priority to an operating system recovery action based on the classification; and
delay the operating system recovery action based on the priority not exceeding a first threshold and exceeding a second threshold.

12. The medium of claim 10, wherein the recovery action comprises an operating system reinstallation.

13. The medium of claim 10, wherein the set of telemetry correspond to a current client computing device state.

14. The medium of claim 10, further comprising the instructions that when executed cause the processor to:
block the operating system recovery action based on the priority exceeding a first threshold.

15. The medium of claim 14 further comprising sending a notification to an automated support system indicating the operating system recovery action was blocked.
